(19) United States
(12) Patent Application Publication
(10) Pub. No.: US 2009/0031262 A1
(43) Pub. Date: Jan. 29, 2009

(54) MASK PATTERN FORMATION METHOD, MASK PATTERN FORMATION APPARATUS, AND LITHOGRAPHY MASK

(76) Inventors: Shimon Maeda, Tokyo (JP); Suigen Kyoh, Yokohama-shi (JP); Soichi Inoue, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/179,735

(22) Filed: Jul. 25, 2008

(30) Foreign Application Priority Data
Jul. 26, 2007 (JP) 2007-194017

(51) Int. Cl. G06F 17/50

(52) U.S. Cl. 716/2; 716/5; 716/21

(57) ABSTRACT

A mask pattern formation method and apparatus capable of performing OPC and lithography verification and obtaining OPC result, and a lithography mask are provided. The method of forming a mask pattern from a design layout of a semiconductor integrated circuit comprises inputting a design layout, performing first OPC on the design layout, calculating a first evaluation value for a finished planar shape of a resist pattern corresponding to the design layout based on the first OPC, determining whether the first evaluation value satisfies a predetermined value, if the first evaluation value does not satisfy the predetermined value, locally altering the design layout, performing second OPC on the altered design layout, calculating a second evaluation value for the altered design layout, performing second determination, and if the second evaluation value satisfies the predetermined value, outputting the result of OPC and the first and second evaluation values.

### CROSS-REFERENCE TO RELATED APPLICATIONS

This application is based upon and claims the benefit of priority from prior Japanese Patent Application No. 2007-194017, filed Jul. 26, 2007, the entire contents of which are incorporated herein by reference.

### BACKGROUND OF THE INVENTION

1. Field of the Invention

The present invention relates to a technique of forming a mask pattern of a semiconductor integrated circuit and, more particularly, to a mask pattern formation method and mask pattern formation apparatus having an optical proximity correction (OPC) function and a function of verifying the OPC function. The present invention also relates to a lithography mask formed by using this mask pattern formation method.

2. Description of the Related Art

The progress of the recent semiconductor fabrication techniques is very remarkable, and semiconductor devices having a feature size of 0.13 μm are mass-produced. Micropatterning like this is achieved by the rapid progress of the fine pattern formation techniques such as the mask process technique, photolithography technique, and etching technique.

However, as micropatterning advances, it has become difficult to faithfully form a pattern in each process. This poses the problem that the final finished pattern dimension on a wafer does not conform to the designed pattern dimension. Solving this problem requires lithography verification. This lithography verification requires a very long time because it is also necessary to verify an OPC process of correcting the optical proximity effect.

As described above, as micropatterning of semiconductor integrated circuits advances, the necessity of lithography verification is increasing even in a designing stage of generating a mask pattern from a design layout, and this lithography verification requires a very long processing time. To actually form a mask after design values are determined, correction data must be formed by OPC. When the processing time of this OPC is included, the total time required for mask formation is enormous.

### BRIEF SUMMARY OF THE INVENTION

According to one aspect of the present invention, there is provided a mask pattern formation method of forming a mask pattern from a design layout of a semiconductor integrated circuit such that a resist pattern with a desired shape is obtained on a wafer, the method comprising: inputting a design layout of a semiconductor integrated circuit; performing first process optical proximity correction (OPC) on the input design layout; calculating a first evaluation value for a finished planar shape of a resist pattern on a wafer, which corresponds to the design layout, on the basis of a result of the first OPC; determining whether the calculated first evaluation value satisfies a predetermined value; if it is determined that the first evaluation value does not satisfy the predetermined value, locally altering the design layout on the basis of at least one of a position coordinate and the first evaluation value of an unsatisfying portion; performing second OPC on the altered design layout; calculating a second evaluation value for a finished planar shape of a resist pattern on the wafer, which corresponds to the altered design layout, on the basis of a result of the second OPC; performing second determination on whether the calculated second evaluation value satisfies the predetermined value; and if it is determined that the second evaluation value satisfies the predetermined value, outputting at least one of the result of the process optical proximity correction and the calculated first and second evaluation values.

According to another aspect of the present invention, there is provided a mask pattern formation method of forming a mask pattern from a design layout of a semiconductor integrated circuit such that a resist pattern with a desired shape is obtained on a wafer, the method comprising: inputting a design layout of a semiconductor integrated circuit; performing first process optical proximity correction (OPC) on the input design layout; extracting an alteration region from the corrected design layout, and altering an uncorrected design layout portion in the alteration region; performing second OPC on the altered design layout portion; and synthesizing a result of the first OPC and a result of the second OPC, and outputting the synthesized result.

According to another aspect of the present invention, there is provided a mask pattern formation apparatus for forming a mask pattern from a design layout of a semiconductor integrated circuit such that a resist pattern with a desired shape is obtained on a wafer, the apparatus comprising: a first unit configured to input a design layout of a semiconductor integrated circuit; a second unit configured to perform first process optical proximity correction (OPC) on the input design layout; a third unit configured to calculate a first evaluation value for a finished planar shape of a resist pattern on a wafer, which corresponds to the design layout, on the basis of a result of the first OPC; a fourth unit configured to determine whether the calculated first evaluation value satisfies a predetermined value; a fifth unit configured to, if the fourth unit determines that the first evaluation value does not satisfy the predetermined value, locally alter the design layout on the basis of at least one of a position coordinate and the first evaluation value of an unsatisfying portion; a sixth unit configured to locally perform second OPC on a design layout in the altered design layout region; a seventh unit configured to cause the fourth unit to locally calculate a second evaluation value for a finished planar shape of a resist pattern on the wafer, which corresponds to a design layout in the altered design layout region, on the basis of a result of the second OPC performed by the sixth unit, and to determine whether the calculated second evaluation value satisfies a predetermined value; and an eighth unit configured to, if the fourth unit determines that the second evaluation value satisfies the predetermined value, output the OPC result obtained by the second unit, or synthesize the OPC results obtained by the second unit and the sixth unit and output the synthesized result.

According to another aspect of the present invention, there is provided a lithography mask comprising a mask pattern formed on a mask substrate and obtained by using a mask pattern formation method of performing process optical proximity correction (OPC) on a design layout of a semiconductor integrated circuit, the mask pattern formation method comprising: inputting a design layout of a semiconductor integrated circuit; performing first process optical proximity correction (OPC) on the input design layout; calculating a first evaluation value for a finished planar shape of a resist pattern on a wafer, which corresponds to the design layout, on the basis of a result of the first OPC; determining whether the calculated first evaluation value satisfies a predetermined value; if it is determined that the first evaluation value does not satisfy the predetermined value, locally altering the design layout on the basis of at least one of a position coordinate and the first evaluation value of an unsatisfying portion; performing second OPC on the altered design layout; calculating a second evaluation value for a finished planar shape of a resist pattern on the wafer, which corresponds to the altered design layout, on the basis of a result of the second OPC; performing second determination on whether the calculated second evaluation value satisfies the predetermined value; and if it is determined that the second evaluation value satisfies the predetermined value, outputting at least one of the result of the process optical proximity correction and the calculated first and second evaluation values.

### BRIEF DESCRIPTION OF THE SEVERAL VIEWS OF THE DRAWING

FIG. 1 is a flowchart for explaining the procedure of chip designing according to the first embodiment;

FIG. 2 is a flowchart showing an exemplary procedure of a process based on a litho-friendly designing according to the first embodiment;

FIG. 3 is a flowchart showing another example of an exemplary procedure of a process based on the litho-friendly designing according to the first embodiment;

FIG. 4 is a flowchart for explaining the main part of the procedure of chip designing according to the second embodiment;

FIG. 5 is a flowchart for explaining the main part of the procedure of chip designing according to the second embodiment;

FIG. 6 is a flowchart for explaining the main part of the procedure of chip designing according to the third embodiment;

FIG. 7 is a flowchart for explaining the main part of the procedure of chip designing according to the fourth embodiment;

FIG. 8 is a plan view schematically showing a pattern conforming to the flowchart shown in FIG. 7;

FIG. 9 is a flowchart for explaining the major part of the procedure of chip designing according to the fifth embodiment;

FIG. 10 is a plan view schematically showing a pattern conforming to the flowchart shown in FIG. 9;

FIG. 11 is a flowchart for explaining the major part of the procedure of chip designing according to the sixth embodiment; and

FIG. 12 is a plan view schematically showing a pattern conforming to the flowchart shown in FIG. 11.

### DETAILED DESCRIPTION OF THE INVENTION

The present invention provides a mask pattern formation method and a mask pattern formation apparatus capable of performing an optical proximity correction (OPC) process and lithography verification and obtaining the OPC process result in the stage of chip designing, thereby shortening the total time required for mask formation, and also provides a lithography mask.

The embodiments of the present invention will be described with reference to the accompanying drawings. Throughout the drawings, corresponding portions are denoted by corresponding reference numerals.

### First Embodiment

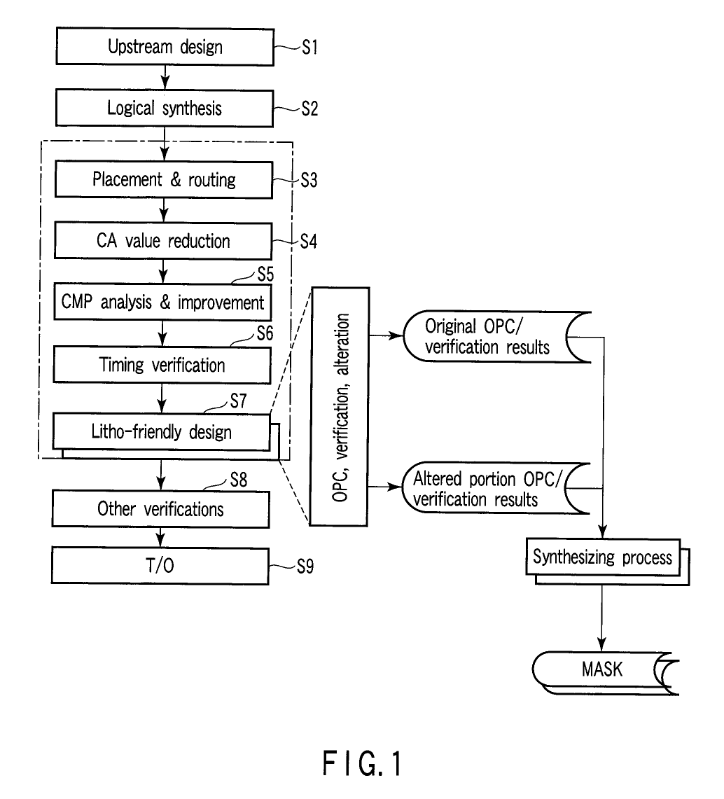

FIG. 1 is a flowchart for explaining the procedure of chip designing according to the first embodiment of the present invention.

First, as upstream design (step S1), the connection interval of blocks such as logic elements is described, and whether the input/output connections satisfy given criteria is checked by simulation. Then, logical synthesis that converts the blocks into logic blocks (AND, OR gates) is performed (step S2). The placement and routing of the logic blocks are determined on the basis of a cell library (step S3). That is, an efficient placement that reduces the necessary area is determined by taking the operation timing of each block into account.

Subsequently, the critical area is reduced, and the distances between interconnections are optimized (step S4). To planarize the surface of the substrate, processes such as a process of forming a dummy interconnection in a region where the distance between interconnections is long are performed (step S5). Whether each device normally operates in the pattern placement obtained by the processes in steps S3 and S4 is verified by including the influence of, e.g., a delay caused by the interconnection length as well (step S6).

Then, so-called, litho-friendly design processing is performed (step S7). This processing verifies the design layout (design) by referring to a predetermined rule, and removes a layout portion having a problem such as the inability to ensure a sufficient process margin. That is, OPC, OPC verification, and design alteration are performed, and the results of OPC and OPC verification of the initial design layout or the results of OPC and OPC verification of the altered portion are output. After that, a layout obtained by synthesizing these outputs is recorded as information to be used when forming a mask.

When the litho-friendly design processing is complete, design rule check, circuit connection verification, and the like are performed (step S8). Finally obtained design data not having undergone OPC is stored in a storage unit such as a magnetic tape (step S9).

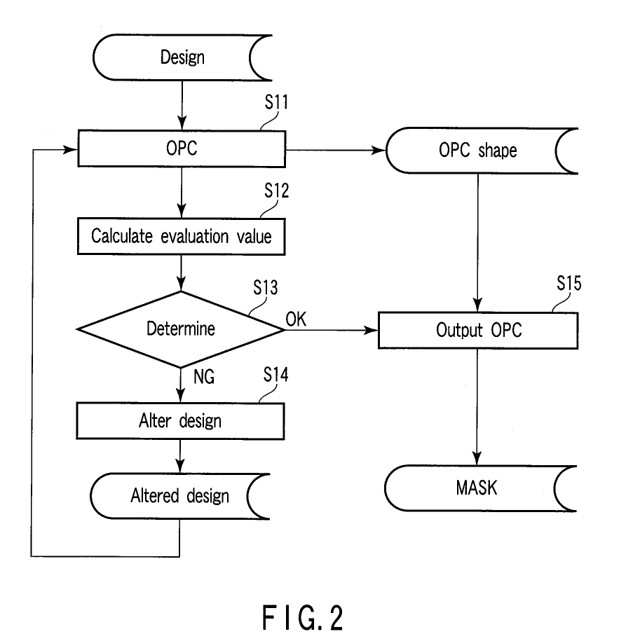

An exemplary procedure of the processing using litho-friendly design in step S7 will be explained below with reference to a flowchart shown in FIG. 2.

First, the design layout (design) of a semiconductor integrated circuit is input. After that, to perform lithography verification during a process after placement and routing, process OPC (Optical Proximity Correction) is performed on the whole design of the input design layout (step S11).

Then, OPC verification is performed on the basis of the result of the process optical proximity correction, and an evaluation value for the finished planar shape of the resist pattern on the wafer is calculated (step S12). Subsequently, whether the calculated evaluation value satisfies a predetermined value is checked (step S13). That is, lithography verification is performed on the OPC result.

This lithography verification checks at least one of, e.g., whether the pattern short-circuits on the wafer, whether the pattern opens on the wafer, whether the pattern completely covers a via on the wafer, whether the pattern has excessively degenerated on the wafer, whether the slope of the light intensity is moderate, and whether the OPC residue is large. A predetermined reference value is set for each of these items to be checked. For example, when a pattern space dimension of 50 nm or more is set as a necessary criterion, a portion where the pattern space dimension is found to be less than 50 nm by lithography simulation is regarded as an error portion because the predetermined reference value is not met.

If a portion where the predetermined reference value is not met is found by lithography verification, the coordinate value and degree of criticalness of the portion are output. The degree of criticalness is set stepwise on the basis of the simulation value in lithography simulation.

Then, a design alteration region is formed around the output coordinate value, and design data contained in the region is altered on the basis of the output degree of criticalness (step S14). That is, the design layout is locally altered on the basis of at least one of the position coordinates and evaluation value. The method of alteration can be any of a manual method, table base correction by which correction amounts are allocated in accordance with the degree of criticalness, an automatic method based on lithography simulation, and rerouting.

After the design is altered, OPC and lithography verification are performed again to check whether there are any side-effects. That is, the process returns to step S11 to reexecute process optical proximity correction on the altered design layout (design) in step S11, and calculate an evaluation value in step S12. The processing is repeated until it is determined in step S13 that the calculated evaluation value satisfies the predetermined value.

OPC and lithography verification can be performed on the whole layout or in the design alteration region. The latter is favorable from the viewpoint of the processing time. The same processing is repeated if an error is found again by lithography verification. If no problem is found, the design is determined at that point of time.

Simultaneously, the result of the OPC executed in the above processing is output. That is, if it is finally determined in step S13 that the calculated evaluation value satisfies the predetermined value, the result (OPC shape) of process optical proximity correction finally obtained in step S11 is extracted and output (step S15). For example, when lithography verification is performed from a second metal layer to a sixth metal layer, all mask patterns from the second metal layer to the sixth metal layer can be output before an OPC process after the design is determined. This OPC shape is recorded as data for mask formation.

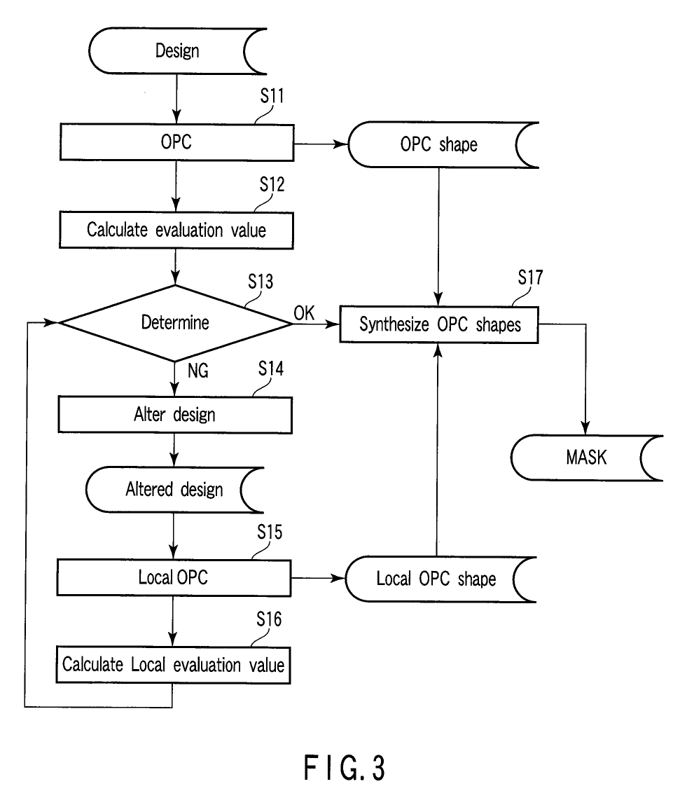

FIG. 3 is a flowchart showing another procedure of the litho-friendly design processing in step S7. Steps S11 to S14 in FIG. 3 are the same as in FIG. 2.

On the basis of the position coordinates, process optical proximity correction is locally performed on the design layout (altered design) having undergone design alteration in step S14 (step S15). Then, on the basis of the result of this local process optical proximity correction, an evaluation value for the finished planar shape of the resist pattern on the wafer is locally calculated (step S16). The process then returns to step S13 to check whether the evaluation value calculated in step S16 satisfies the predetermined value. Steps S13 to S16 are repeated until it is determined that the calculated evaluation value satisfies the predetermined value.

If it is determined in step S13 that the evaluation value satisfies the predetermined value, the process optical proximity correction result obtained step S11 and the local process optical proximity correction result finally obtained in step S15 are extracted and synthesized (step S17). The synthesized OPC shape is recorded as data for mask formation.

In this embodiment as described above, it is possible to verify a mask pattern and obtain data having undergone OPC at the same time in a designing stage of generating a mask pattern from the design layout of an integrated circuit. That is, data of an OPC shape concerning a mask pattern can be obtained at the same time the designing stage is complete. This makes it possible to shorten the total processing time necessary for mask formation or manufacture.

### Second Embodiment

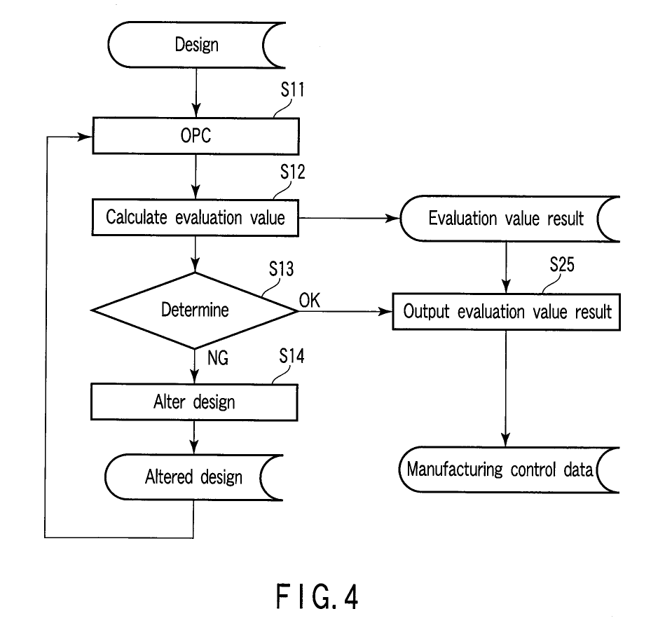

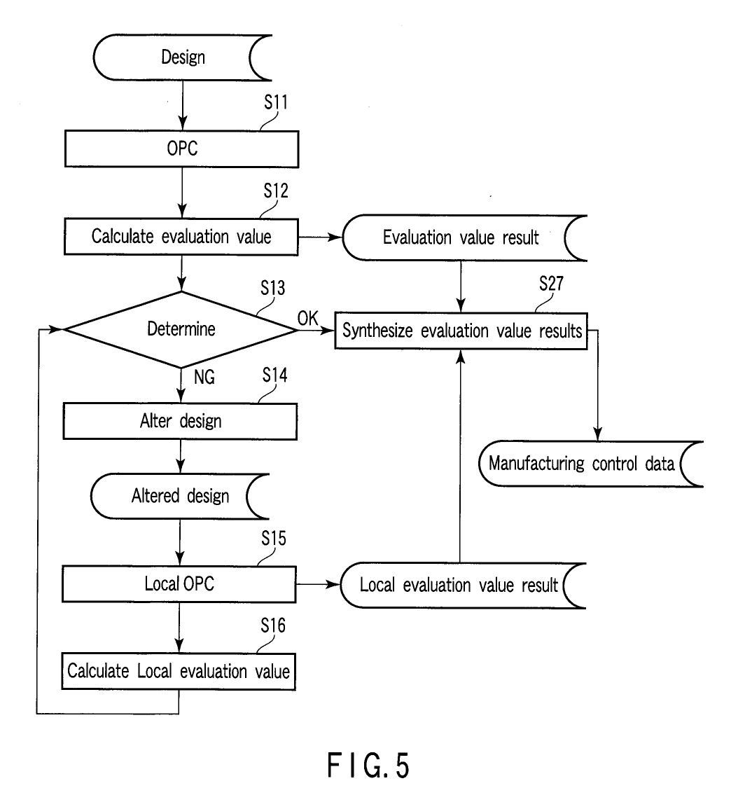

FIGS. 4 and 5 are flowcharts for explaining the main part of the procedure of chip designing according to the second embodiment of the present invention, and illustrate exemplary examples of the procedure of litho-friendly design (step S7) shown in FIG. 1.

In the flowchart shown in FIG. 4, steps S11 to S14 are the same as in FIG. 2.

This embodiment differs from the first embodiment (FIG. 2) in that if it is determined in step S13 that the evaluation value calculated in step S12 satisfies the predetermined value, the evaluation value finally obtained in step S12 is extracted and output (step S25). It is also possible to simultaneously output the process optical proximity correction result obtained in step S11. The output result is recorded as manufacturing control data.

In the flowchart shown in FIG. 5, steps S11 to S16 are the same as in FIG. 3.

This embodiment differs from the first embodiment (FIG. 3) explained previously in that if it is determined in step S13 that the evaluation value calculated in step S12 satisfies the predetermined value, the evaluation value obtained in step S12 and the evaluation value finally obtained in step S16 are extracted and synthesized (step S27). It is also possible to simultaneously output the process optical proximity correction result obtained in step S11 and the local process optical proximity correction result finally obtained in step S15. The synthetic output result is recorded as manufacturing control data.

In this embodiment as described above, not only the OPC result but also the coordinates or degree of criticalness of a critical portion as the result of executed lithography verification are output. This makes it possible to output a point to be observed in the manufacturing from the viewpoint of lithography after the design is determined and before an OPC process and lithography verification are performed in a later step.

For example, the throughput of mask formation can be increased by setting a large exposure margin for a pattern near the border line as an evaluation value on the basis of the manufacturing control data.

### Third Embodiment

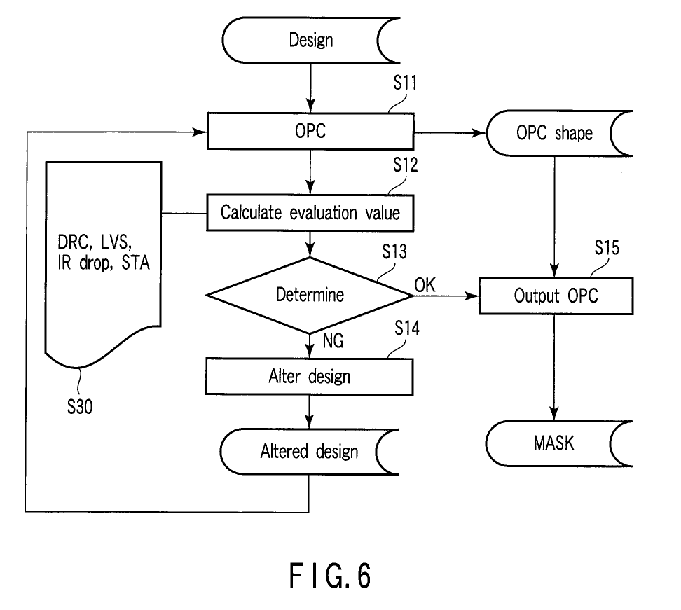

FIG. 6 is a flowchart for explaining the main part of the procedure of chip designing according to the third embodiment of the present invention, and shows an exemplary example of the processing using litho-friendly design (step S7) shown in FIG. 1.

The basic flow from steps S11 to S15 is the same as in FIG. 2.

This embodiment is characterized in that in step S12, design rule verification, circuit connection verification, timing verification, voltage drop verification, coverage verification, critical area verification, the calculation of an evaluation value for a finished planar shape of the resist pattern on a wafer, and the like are performed on the design layout input in step S11, on the basis of various kinds of information stored in a storage unit S30. In step S12, it is not always necessary to perform all the verifications and calculations, and it is also possible to selectively perform one or more of these verifications and calculations.

In the first embodiment explained previously, design verification must be performed after design alteration. As indicated by the flowchart shown in FIG. 6, therefore, design rule verification, circuit connection verification, timing verification, voltage drop verification, coverage verification, or critical area verification are performed on the altered design in step S12. This makes it possible to efficiently perform design verification.

### Fourth Embodiment

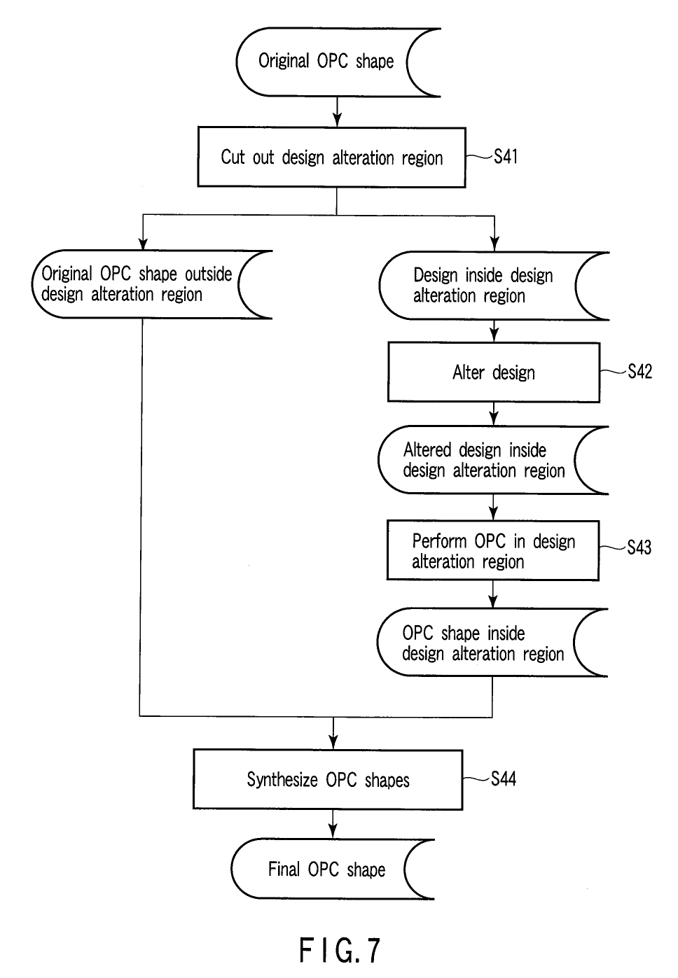

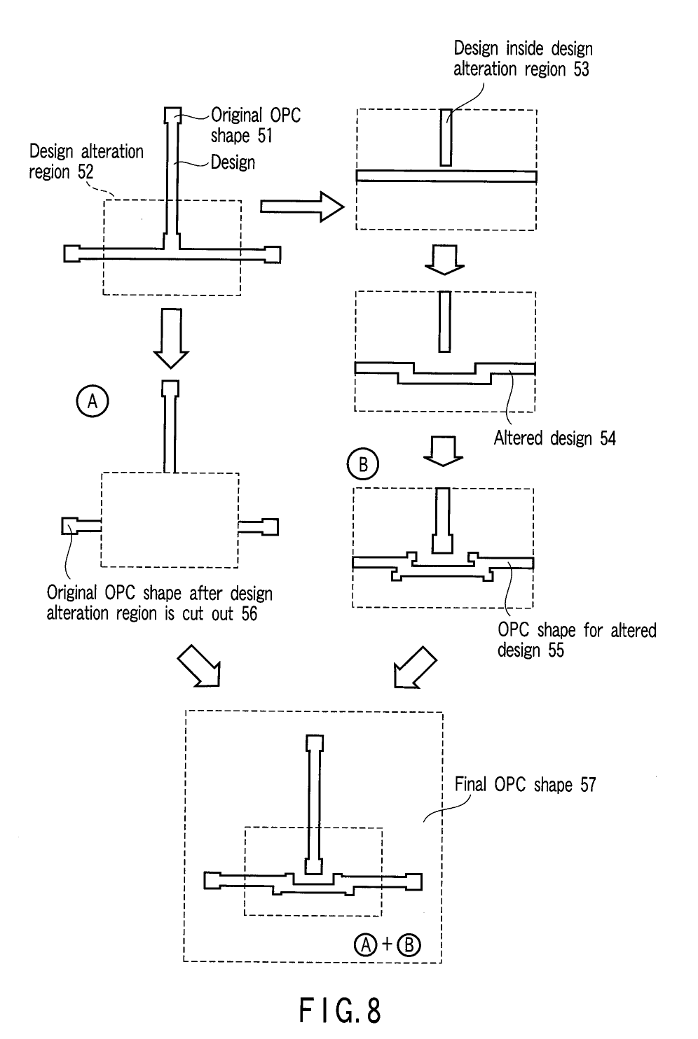

FIG. 7 is a flowchart for explaining the major part of the procedure of chip designing according to the fourth embodiment of the present invention, and shows an exemplary example of the OPC process (step S1) shown in FIG. 2. FIG. 8 shows a pattern conforming to this flowchart.

First, an original OPC shape 51 is input, a design alteration region 52 is cut out (step S41), and the original OPC shape 51 outside the design alteration region and a design 53 inside the design alteration region are extracted.

Then, the design inside the design alteration region 52 is altered (step S42), thereby obtaining an altered design 54 inside the design alteration region.

Subsequently, an OPC shape 55 inside the design alteration region is obtained by performing an OPC process on the altered design 54 (step S43).

The original OPC shape 51 outside the design alteration region and the OPC shape 55 inside the design alteration region obtained in step S43 are synthesized (step S44). The synthetic OPC shape is output as a final OPC shape 57.

In this embodiment as described above, the design alteration region 52 estimated as a critical portion of the pattern is cut out, and the OPC process is performed on this portion. Since no OPC process is performed on a pattern outside the design alteration region 52, the time required for the OPC process can be shortened.

### Fifth Embodiment

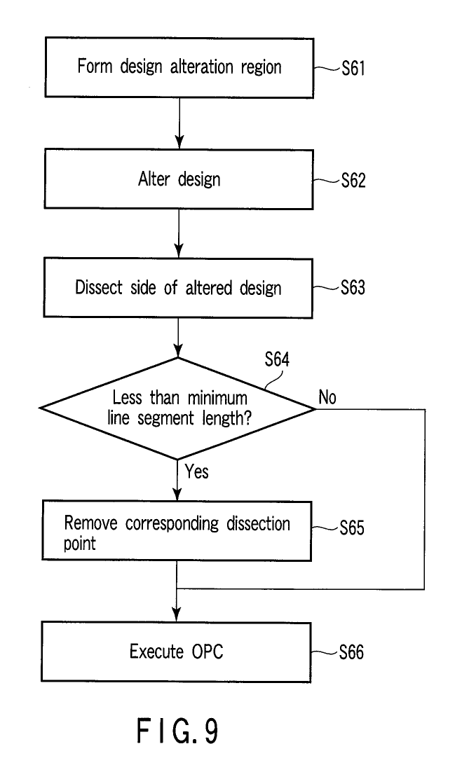

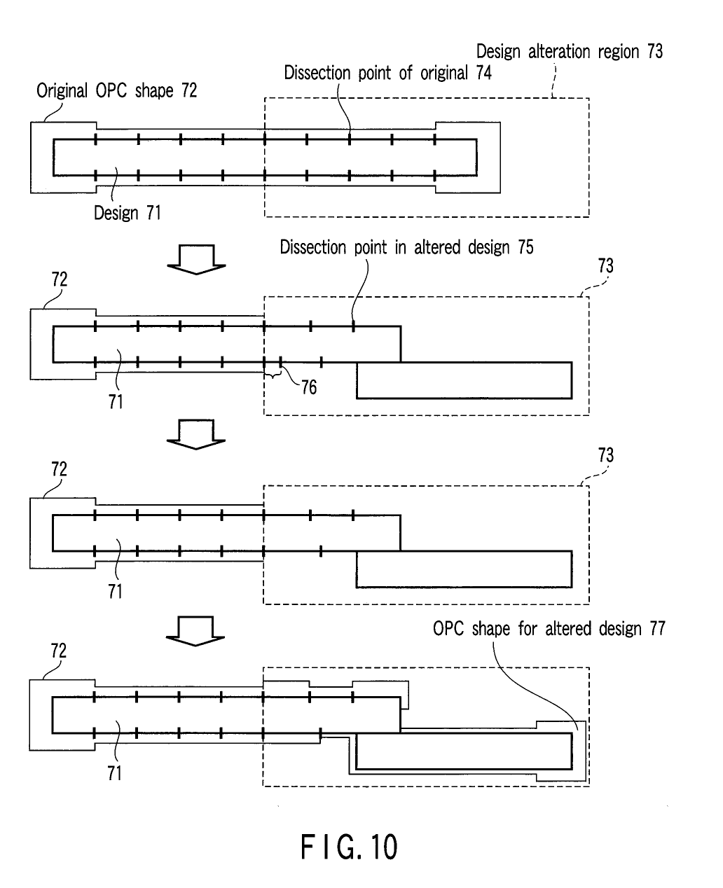

FIG. 9 is a flowchart for explaining the major part of the procedure of chip designing according to the fifth embodiment of the present invention, and shows an exemplary example of the OPC process (step S11) shown in FIG. 2. FIG. 10 exemplarily shows a pattern conforming to this flowchart.

In FIG. 10, reference numeral 71 denotes a design; 72; an original OPC shape; 73, a design alteration region; 74, an original dissection point; 75, a dissection point in an altered design; 76, a dissection point to be deleted; and 77, an OPC shape for the altered design. Note that the boundary lines of the design alteration region 73 match the original dissection points 74.

First, the design alteration region 73 is formed on the basis of the coordinates of an error portion (step S61). That is, the design alteration region 73 is formed on the basis of at least one of the position coordinates, the optical radius, and the dissection points used in step S11 of the first embodiment. The design alteration region 73 is formed by drawing a circle around the coordinates of the error portion by using the same value as (or the twofold value of) the optical radius (about 1 μm). The design alteration region 73 may also be a square or rectangle.

Conversely, “dissection points” used when OPC is performed on the original exist. The dissection points exist on the sides of the original design. A portion dissected by “the dissection points” is expressed as a segment.

Whether each segment is inside or outside the design alteration region 73 is checked. If the whole segment exists inside the design alteration region 73, it is determined that the segment is inside. If even a portion of the segment extends outside the design alteration region 73, it is determined that the segment is outside.

Subsequently, a design contained in the design alteration region is altered (step S62).

Dissection is then performed on the altered design contained in the design alteration region 73 (step S63). The method of dissection can be the same as that performed on the original design. Consequently, the dissection points 75 and 76 are generated in the altered design.

Whether the length of a line segment generated by the dissection near the boundary of the design alteration region 73 is less than an initially given minimum line segment length is checked (step S64). If the line segment length is less than the defined value, “the dissection point” 76 having generated this nonstandard value is removed (step S65). This eliminates line segments shorter than the minimum line segment length in the altered design.

Finally, OPC is performed in the design alteration region on the basis of the “dissection points” obtained following the above procedure (step S66). As a consequence, the OPC shape 77 of the altered design is obtained.

The above processing makes it possible to prevent the generation of a fine figure near the boundary of the design alteration region 73.

### Sixth Embodiment

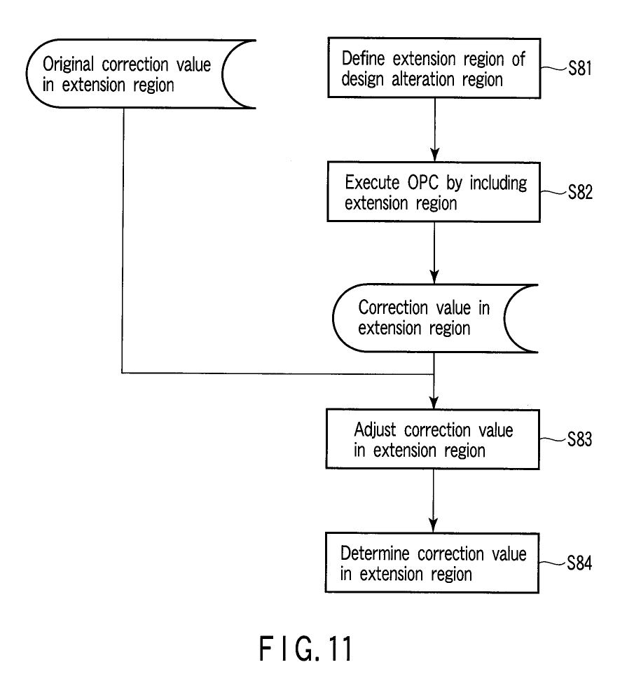

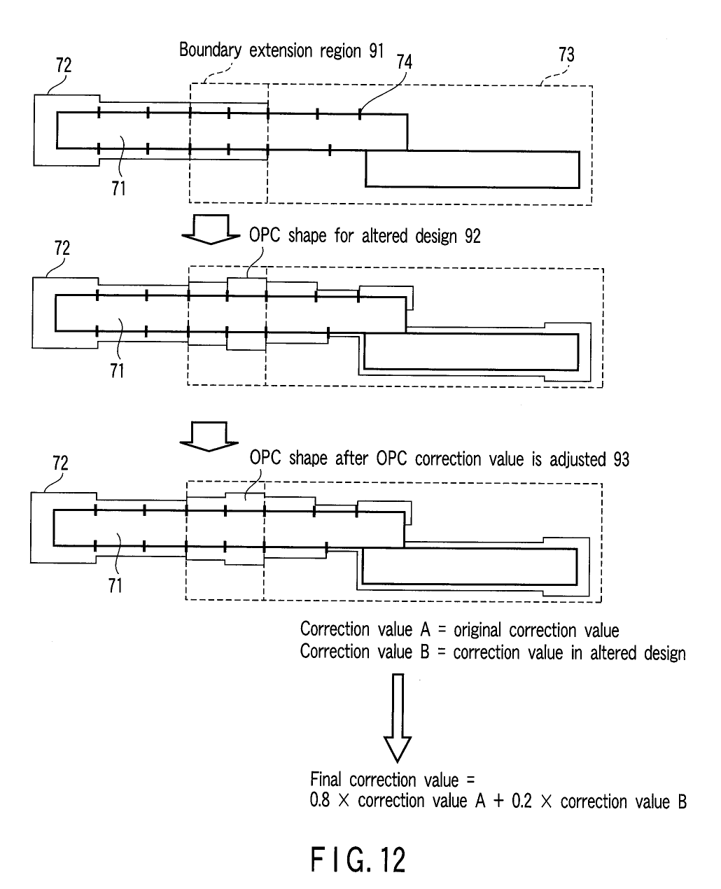

FIG. 11 is a flowchart for explaining the major part of the procedure of chip designing according to the sixth embodiment of the present invention, and shows an exemplary example of the OPC process (step S11) shown in FIG. 2. FIG. 12 exemplarily shows a pattern conforming to this flowchart.

An extension region 91 is defined outside a design alteration region 73 explained in the fifth embodiment (step S81). The design alteration region 73 is formed by the same method as explained in the fifth embodiment. The extension region 91 is also formed by the same method. The difference is that the radius of the extension region 91 is greater than that of the design alteration region 73. More specifically, the radius is appropriately 100 to 500 nm.

Then, whether a line segment formed by dissection points 74 is outside or inside the design alteration region 73 is checked by the same method as explained in the fifth embodiment. Whether the line segment is outside or inside the extension region 91 is also checked by the same method.

Subsequently, OPC is performed in the design alteration region 73 or extension region 91 (step S82). This gives the extension region 91 two types of OPC shapes, i.e., an original OPC shape 72 and an OPC shape 92 corresponding to the altered design.

Next, OPC correction value adjustment is performed in the extension region 91 (step S83). More specifically, letting A be the correction value of the original and B be the correction value of the altered design, the adjustment is performed such that final correction value=0.8×correction value A+0.2×correction value B (step S84).

This achieves the effect of smoothing the boundary between the original OPC shape 72 and the OPC shape 92 of the altered design. Reference numeral 93 in FIG. 12 denotes the adjusted OPC shape inside the extension region 91.

As described above, this embodiment can of course achieve the same effect as in the fifth embodiment, and can also decrease the step of OPC near the boundary of the design alteration region 73.

### Seventh Embodiment

The arrangement of a mask pattern formation apparatus for performing the mask pattern formation methods based on the above embodiments will be explained below. That is, a mask pattern formation apparatus for forming a mask pattern from a design layout of a semiconductor integrated circuit such that a desired shape is obtained on a wafer is characterized by comprising a first unit configured to input a design layout of a semiconductor integrated circuit, a second unit configured to perform process optical proximity correction on the input design layout, a third unit configured to calculate an evaluation value for a finished planar shape of the resist pattern on a wafer, which corresponds to the design layout, on the basis of the result of the process optical proximity correction, a fourth unit configured to determine whether the calculated evaluation value satisfies a predetermined value, a fifth unit configured to, if the fourth unit determines that the evaluation value does not satisfy the predetermined value, locally alter the design layout on the basis of at least one of a position coordinate and the evaluation value, a sixth unit configured to locally perform process optical proximity correction on a design layout in the altered design layout region, a seventh unit configured to locally calculate a evaluation value for a finished planar shape of the resist pattern on the wafer, which corresponds to the design layout in the altered design layout region, on the basis of the result of the process optical proximity correction performed by the sixth unit, and cause the fourth unit to determine whether the calculated evaluation value satisfies a predetermined value, and an eighth unit configured to, if the fourth unit determines that the evaluation value satisfies the predetermined value, output the process optical proximity correction result obtained by the second unit, or synthesize the process optical proximity correction results obtained by the second and sixth units and output the result of the synthesis.

### Eighth Embodiment

A mask pattern formed by the mask pattern formation method based on any of the above embodiments can be formed on a lithography mask substrate by, e.g., an electron beam lithography apparatus. Also, when the mask is set in an exposure system and irradiated with exposure light, the pattern can be transferred to a resist film on the substrate surface set below the mask. In addition, holes for forming interconnection patterns, gate patterns, contacts, vias, and the like can be formed by forming a resist pattern by developing the resist film, and etching a film to be processed by using the resist pattern as a mask. Furthermore, a semiconductor device including interconnections and gate electrodes can be manufactured by burying conductors in the holes.

### MODIFICATIONS

Note that the present invention is not limited to the above embodiments, and can be variously modified and practiced without departing from the spirit and scope of the invention. For example, the OPC shape is output in the first embodiment, and the evaluation value is output in the second embodiment. However, both the OPC shape and evaluation value may also be output. It is also possible to omit the step/unit for calculating the evaluation value on the basis of the finished planar shape of the resist pattern of the design layout on the wafer, and/or the step/unit for determining whether the calculated value satisfies the predetermined value, from the pattern formation method/apparatus.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A mask pattern formation method of forming a mask pattern from a design layout of a semiconductor integrated circuit such that a resist pattern with a desired shape is obtained on a wafer, the method comprising:
inputting a design layout of a semiconductor integrated circuit;
performing first process optical proximity correction (OPC) on the input design layout;
calculating a first evaluation value for a finished planar shape of a resist pattern on a wafer, which corresponds to the design layout, on the basis of a result of the first OPC;
determining whether the calculated first evaluation value satisfies a predetermined value;
if it is determined that the first evaluation value does not satisfy the predetermined value, locally altering the design layout on the basis of at least one of a position coordinate and the first evaluation value of an unsatisfying portion;
performing second OPC on the altered design layout;
calculating a second evaluation value for a finished planar shape of a resist pattern on the wafer, which corresponds to the altered design layout, on the basis of a result of the second OPC;
performing second determination on whether the calculated second evaluation value satisfies the predetermined value; and
if it is determined that the second evaluation value satisfies the predetermined value, outputting at least one of the result of the process optical proximity correction and the calculated first and second evaluation values.

2. The method according to claim 1, wherein the second OPC is performed on a whole design layout including the altered design layout.

3. The method according to claim 2, wherein performing the second OPC, calculating the second evaluation value, and performing the second determination are repeated until the whole design layout satisfies the predetermined value.

4. The method according to claim 1, wherein the second OPC is locally performed on the altered design layout.

5. The method according to claim 4, wherein calculating the second evaluation value comprises locally calculating a second evaluation value for a finished planar shape of the resist pattern on the wafer, which corresponds to the locally altered design layout.

6. The method according to claim 4, wherein performing the second determination comprises determining whether the locally calculated second evaluation value satisfies the predetermined value.

7. The method according to claim 4, wherein performing the second OPC, calculating the second evaluation value, and performing the second determination are repeated until the whole design layout satisfies the predetermined value.

8. The method according to claim 4, wherein outputting the result of the OPC comprises outputting the result of the first OPC.

9. The method according to claim 4, wherein outputting the result of the OPC comprises outputting a result of synthesis of the result of the first OPC and the result of the second OPC.

10. The method according to claim 1, wherein performing the first OPC and performing the second OPC comprise checking at least one of whether the pattern short-circuits on the wafer, whether the pattern opens on the wafer, whether the pattern completely covers a via on the wafer, whether the pattern has excessively degenerated on the wafer, whether a slope of light intensity is moderate, and whether an OPC residue is large.

11. The method according to claim 1, wherein the first and second evaluation values include a coordinate and degree of criticalness of a portion which does not satisfy the predetermined value.

12. The method according to claim 1, wherein calculating the first or second evaluation value comprises calculating an evaluation value, on the design layout, on the basis of a result of at least one of design rule verification, circuit connection verification, timing verification, voltage drop verification, coverage verification, critical area verification, and evaluation of a finished planar shape of the resist pattern on the wafer.

13. A mask pattern formation method of forming a mask pattern from a design layout of a semiconductor integrated circuit such that a resist pattern with a desired shape is obtained on a wafer, the method comprising:
inputting a design layout of a semiconductor integrated circuit;
performing first process optical proximity correction (OPC) on the input design layout;
extracting an alteration region from the corrected design layout, and altering an uncorrected design layout portion in the alteration region;
performing second OPC on the altered design layout portion; and
synthesizing a result of the first OPC and a result of the second OPC, and outputting the synthesized result.

14. The method according to claim 13, wherein the first and second OPCs include lithography verification of checking at least one of whether the pattern short-circuits on the wafer, whether the pattern opens on the wafer, whether the pattern completely covers a via on the wafer, whether the pattern has excessively degenerated on the wafer, whether a slope of light intensity is moderate, and whether an OPC residue is large.

15. The method according to claim 14, wherein the alteration region is a region including a critical portion of the pattern, which presumably does not satisfy a predetermined reference value in the lithography verification.

16. The method according to claim 13, wherein performing the alteration comprises setting an extension region adjacent to the alteration region, and altering an uncorrected design layout portion in the alteration region and in the extension region, a alteration value being adjusted in the extension region to smooth the first OPC result outside the extension region and the second OPC result in the alteration region.

17. A mask pattern formation apparatus for forming a mask pattern from a design layout of a semiconductor integrated circuit such that a resist pattern with a desired shape is obtained on a wafer, the apparatus comprising:
a first unit configured to input a design layout of a semiconductor integrated circuit;
a second unit configured to perform first process optical proximity correction (OPC) on the input design layout;
a third unit configured to calculate a first evaluation value for a finished planar shape of a resist pattern on a wafer, which corresponds to the design layout, on the basis of a result of the first OPC;
a fourth unit configured to determine whether the calculated first evaluation value satisfies a predetermined value;
a fifth unit configured to, if the fourth unit determines that the first evaluation value does not satisfy the predetermined value, locally alter the design layout on the basis of at least one of a position coordinate and the first evaluation value of an unsatisfying portion;
a sixth unit configured to locally perform second OPC on a design layout in the altered design layout region;
a seventh unit configured to cause the fourth unit to locally calculate a second evaluation value for a finished planar shape of a resist pattern on the wafer, which corresponds to a design layout in the altered design layout region, on the basis of a result of the second OPC performed by the sixth unit, and to determine whether the calculated second evaluation value satisfies a predetermined value; and
an eighth unit configured to, if the fourth unit determines that the second evaluation value satisfies the predetermined value, output the OPC result obtained by the second unit, or synthesize the OPC results obtained by the second unit and the sixth unit and output the synthesized result.

18. A lithography mask comprising a mask pattern formed on a mask substrate and obtained by using a mask pattern formation method of performing process optical proximity correction (OPC) on a design layout of a semiconductor integrated circuit, the mask pattern formation method comprising:
inputting a design layout of a semiconductor integrated circuit;
performing first process optical proximity correction (OPC) on the input design layout;
calculating a first evaluation value for a finished planar shape of a resist pattern on a wafer, which corresponds to the design layout, on the basis of a result of the first OPC;
determining whether the calculated first evaluation value satisfies a predetermined value;
if it is determined that the first evaluation value does not satisfy the predetermined value, locally altering the design layout on the basis of at least one of a position coordinate and the first evaluation value of an unsatisfying portion;
performing second OPC on the altered design layout;
calculating a second evaluation value for a finished planar shape of a resist pattern on the wafer, which corresponds to the altered design layout, on the basis of a result of the second OPC;
performing second determination on whether the calculated second evaluation value satisfies the predetermined value; and
if it is determined that the second evaluation value satisfies the predetermined value, outputting at least one of the result of the process optical proximity correction and the calculated first and second evaluation values.

19. The mask according to claim 18, wherein the mask pattern formation method performs the second OPC on a whole design layout including the altered design layout region.

20. The mask according to claim 18, wherein the mask pattern formation method locally performs the second OPC on a design layout in the altered design layout region.
